(19) United States
(12) Patent Application Publication
(10) Pub. No.: US 2021/0217015 A1
(43) Pub. Date: Jul. 15, 2021

(54) REWARD VALIDATION FOR MULTIPLE MERCHANT CATEGORY CODE MERCHANTS

(71) Applicant: Mastercard International Incorporated, Purchase, NY (US)

(72) Inventors: Kyle T. Williams, Wentzville, MO (US); David J. Senci, Troy, IL (US); Brett J. Thomson, Lake Saint Louis, MO (US)

(73) Assignee: Mastercard International Incorporated, Purchase, NY (US)

(21) Appl. No.: 16/740,828

(22) Filed: Jan. 13, 2020

(51) Int. Cl. G06Q 20/40

(52) U.S. Cl. CPC G06Q 20/4014; G06Q 20/409

(57) ABSTRACT

Systems for identifying multiple merchant category codes associated with a merchant include a database and a server. The database has a merchant table with several merchant records, which have unique merchant identifiers associated with distinct merchants and one or more active merchant category codes associated with the merchant identifiers. The server receives a clearing transaction message, which includes payment account data associated with an issuer. A transaction merchant identifier in the message is detected by the server. The server retrieves a merchant record that corresponds to the transaction merchant identifier. The server determines whether the merchant record includes several merchant category codes, and if it does, adds an indicator within a first data element and the active merchant category codes within a second data element of the clearing transaction message. The server then transmits the clearing transaction message to the issuer associated with the payment account data.

### FIELD OF THE DISCLOSURE

The field of the disclosure relates generally to electronic payment transactions and, more particularly, to identifying multiple merchant category codes associated with merchants processing electronic payment transactions.

### BACKGROUND OF THE DISCLOSURE

Many payment cards offer reward programs with a wide variety of criteria. Often, the reward amount, if any, is determined by the payment card issuer based in part on a merchant category code (MCC) embedded into the transaction messages, such as the payment authorization request message and/or the clearing transaction message. If a merchant includes an incorrect MCC in the payment transactions messages, the cardholder may miss rewards that otherwise should be applied.

An MCC is included in a data element (DE) of the transaction messages. For example, DE18 (Merchant Type) is the classification (card acceptor business code/merchant category code [MCC]) of the merchant's type of business or service. Each of these MCCs roll up into a higher level “industry/classification,” which simplifies the type of business. There are approximately two hundred and fifty (250) different MCCs available for use, one example of which is MCC 7993—VIDEO AMUSEMENT GAME SUPPLIES. MCC 7993 rolls up to the “Recreation” Industry/Classification.

Incorrect MCCs can be included in payment transaction messages for a number of reasons. For example, a point-of-sale (POS) terminal of the merchant may have been programmed incorrectly, thereby populating each transaction with an incorrect MCC. In addition, many merchants qualify for and use multiple MCCs when processing transactions. Merchants are becoming more dynamic and advanced in how they populate a transaction message. One field or data element that often changes within each transaction is the MCC. While a cardholder may be shopping at a retail location, for example, the MCC the merchant uses in the transaction messages may not fall under a retail MCC. As such, the cardholder could miss rewards that he or she should have been able to receive from the issuer.

### SUMMARY OF THE DISCLOSURE

This brief description is provided to introduce a selection of concepts in a simplified form that are further described in the detailed description below. This brief description is not intended to identify key features or essential features of the claimed subject matter, nor is it intended to be used to limit the scope of the claimed subject matter. Other aspects and advantages of the present disclosure will be apparent from the following detailed description of the embodiments and the accompanying drawing figures.

In one aspect, a system for identifying multiple merchant category codes associated with a merchant processing a transaction is provided. The system includes a database having a merchant table with one or more merchant records therein. Each merchant record includes a unique merchant identifier associated with a distinct merchant and one or more active merchant category codes associated with the unique merchant identifier. The system also includes a server coupled to the database. The server includes a processor programmed to receive a clearing transaction message for the transaction. The clearing transaction message has payment account data associated with an issuer. The processor is also programmed to detect a transaction merchant identifier that is included in the clearing transaction message and retrieve from the merchant table the merchant record having the unique merchant identifier that corresponds to the detected transaction merchant identifier. Moreover, the processor is programmed to determine whether the retrieved merchant record includes two or more active merchant category codes, and if the retrieved merchant record includes two or more active merchant category codes, add an indicator within a first data element of the clearing transaction message. The indicator provides indication that the transaction merchant identifier is associated with two or more merchant category codes. In addition, the processor is programmed to add the two or more active merchant category codes to a second data element of the clearing transaction message and transmit the clearing transaction message to the issuer associated with the payment account data.

In another aspect, a system for identifying multiple merchant category codes associated with a merchant processing a transaction. The system includes a database having a merchant table with one or more merchant records therein. Each merchant record includes a unique merchant identifier associated with a distinct merchant and one or more active merchant category codes associated with the unique merchant identifier. The system also includes a server coupled to the database. The server has a processor programmed to receive a payment authorization request message for the transaction. The payment authorization request message has payment account data associated with an issuer and a merchant identifier. The processor is also programmed to detect a transaction merchant identifier that is included in the payment authorization request message. Furthermore, the processor is programmed to retrieve from the merchant table the merchant record having the unique merchant identifier that corresponds to the detected transaction merchant identifier and determine whether the retrieved merchant record includes two or more active merchant category codes. If the retrieved merchant record includes two or more active merchant category codes, the processor is further programmed to add an indicator within a first data element of a clearing transaction message corresponding to the payment authorization request message. The indicator provides indication that the transaction merchant identifier is associated with two or more merchant category codes. Moreover, the processor is programmed to add the two or more active merchant category codes to a second data element of the clearing transaction message and transmit the clearing transaction message to the issuer associated with the payment account data.

A variety of additional aspects will be set forth in the detailed description that follows. These aspects can relate to individual features and to combinations of features. Advantages of these and other aspects will become more apparent to those skilled in the art from the following description of the exemplary embodiments which have been shown and described by way of illustration. As will be realized, the present aspects described herein may be capable of other and different aspects, and their details are capable of modification in various respects. Accordingly, the figures and description are to be regarded as illustrative in nature and not as restrictive.

### BRIEF DESCRIPTION OF THE DRAWINGS

The figures described below depict various aspects of systems and methods disclosed therein. It should be understood that each figure depicts an embodiment of a particular aspect of the disclosed systems and methods, and that each of the figures is intended to accord with a possible embodiment thereof. Further, wherever possible, the following description refers to the reference numerals included in the following figures, in which features depicted in multiple figures are designated with consistent reference numerals.

FIG. 1 is a block diagram of an example multi-party payment card network system having a merchant category code (MCC) module;

FIG. 2 is a simplified block diagram of an example transaction processing system for providing a “multiple MCC” indicator to issuers in the payment card network shown in FIG. 1;

FIG. 3 is an example configuration of a user system operated by a cardholder shown in FIG. 1;

FIG. 4 is an example configuration of the server system shown in FIG. 2;

FIG. 5 is a schematic diagram of the payment card network system shown in FIG. 1, showing data flow among the parties during a payment transaction;

FIG. 6 is a flowchart illustrating an exemplary computer-implemented method for identifying multiple MCCs associated with a merchant processing a transaction with a cardholder shown in FIG. 1, in accordance with one embodiment of the present disclosure; and

FIG. 7 is a flowchart illustrating an exemplary computer-implemented method for identifying multiple MCCs associated with a merchant processing a transaction with the cardholder shown in FIG. 1, in accordance with another embodiment of the present disclosure.

Unless otherwise indicated, the figures provided herein are meant to illustrate features of embodiments of this disclosure. These features are believed to be applicable in a wide variety of systems comprising one or more embodiments of this disclosure. As such, the figures are not meant to include all conventional features known by those of ordinary skill in the art to be required for the practice of the embodiments disclosed herein.

### DETAILED DESCRIPTION OF THE DISCLOSURE

The following detailed description of embodiments of the invention references the accompanying figures. The embodiments are intended to describe aspects of the invention in sufficient detail to enable those with ordinary skill in the art to practice the invention. The embodiments of the invention are illustrated by way of example and not by way of limitation. Other embodiments may be utilized and changes may be made without departing from the scope of the claims. The following description is, therefore, not limiting. It is contemplated that the invention has general application to identifying multiple merchant category codes associated with a merchant processing a payment transaction and populating a transaction message with the identified merchant category codes. The scope of the present invention is defined only by the appended claims, along with the full scope of equivalents to which such claims are entitled.

The terms “payment card,” “transaction card,” “card,” and the like, as used herein, includes a payment card that can be presented by a cardholder to make a payment or that can be used by the cardholder to make a payment in a remote transaction, such as an e-commerce transaction, telephone transaction, or mail order transaction. For example, and without limitation, the payment cards described herein include credit cards, debit cards, charge cards, stored-value cards, and/or prepaid cards.

As used herein, the term “database” includes either a body of data, a relational database management system (RDBMS), or both. As used herein, a database includes, for example, and without limitation, a collection of data including hierarchical databases, relational databases, flat file databases, object-relational databases, object oriented databases, and any other structured collection of records or data that is stored in a computer system. Examples of RDBMS's include, for example, and without limitation, Oracle® Database (Oracle is a registered trademark of Oracle Corporation, Redwood Shores, Calif.), MySQL, IBM® DB2 (IBM is a registered trademark of International Business Machines Corporation, Armonk, N.Y.), Microsoft® SQL Server (Microsoft is a registered trademark of Microsoft Corporation, Redmond, Wash.), Sybase® (Sybase is a registered trademark of Sybase, Dublin, Calif.), and PostgreSQL. However, any database may be used that enables the systems and methods to operate as described herein.

Embodiments of the present technology relate to systems, methods, and computer-readable media for populating a transaction message with each of the merchant category codes that is associated with a merchant. Embodiments of the present technology provide an issuer with each active merchant category code (MCC) associated with a merchant processing a transaction. As such, an issuer is able to determine, for example, whether to issue a reward to a cardholder, block/allow a transaction, etc. based on all of the MCCs associated with the merchant, rather than just the MCC included in the payment authorization request message.

According to one embodiment of the disclosure, a computing system is configured to receive an authorization request message and/or a clearing transaction message having payment account data associated with an issuer. Generally, a merchant processing a payment transaction submits a payment authorization request message to the issuer to authorize the payment. Subsequently, the issuer may transmit a clearing transaction message to clear and settle the transaction. Such a process is typically referred to as a dual-message transaction, using a payment authorization request message and a separate clearing transaction message. However, some transactions are processed as a single-message transaction in which the transaction is authorized and cleared in a single message. In such instances, the payment authorization request message includes or functions as the clearing transaction message as well.

After receiving the payment authorization message and/or the clearing transaction message, a payment processor detects the merchant identifier (ID) in the message and retrieves, from a merchant table stored in a database, a merchant record that corresponds to the merchant ID. The merchant record includes one or more active MCCs associated with the merchant ID. If the merchant record indicates that two or more active MCCs are associated with the merchant ID, the payment processor may flag the payment authorization message and, based on the flag, subsequently add an indicator within a first data element of the clearing transaction message associated with the payment authorization message. The indicator provides to the issuer an indication that the merchant ID is associated with two or more MCCs. In addition, the payment processor adds the MCCs to a second data element of the clearing transaction message.

Typically, the clearing transaction message does not include such an indicator nor a list of MCCs associated with the merchant ID. However, the embodiments described herein provide for an improved clearing transaction message that includes a new data element for the indicator and a new data element for the MCC list.

The methods and systems described herein may be implemented using computer programming or engineering techniques including computer software, firmware, hardware, or any combination or subset therefor. At least one of the technical problems addressed by this system includes the problem of a merchant using an inaccurate and/or incorrect MCC when processing a transaction, thereby potentially causing a cardholder to miss potential rewards issued by the payment card issuer. Another technical problem addressed by this system includes that of an issuer being unaware of the multiple MCCs used by a merchant, and thereby inaccurately authorizing or declining a transaction of its cardholder based on an inaccurate MCC used in the payment authorization message. Inaccurate authorization or declination of a transaction based on an inaccurate MCC may result in the use additional network resources, for example, due to the creation of a chargeback for an in accurately authorized transaction or to execution of an additional transaction to perform a transaction that was in accurately declined. Thus, an additional technical problem addressed by this system includes improving payment system and/or network performance and efficiency by notifying an issuer of the multiple MCCs used by a merchant.

A technical effect of the systems and methods described herein is achieved by performing at least one of the following operations: (i) receiving a payment authorization message and/or a clearing transaction message for the transaction; (ii) detecting a transaction merchant ID that is included in the message; (iii) retrieving a merchant record having the unique merchant ID that corresponds to the detected transaction merchant ID; (iv) determining whether the retrieved merchant record includes two or more active MCCs; (v) if the retrieved merchant record includes two or more active MCCs, adding an indicator within a first data element of the message; (vi) adding the two or more active MCCs to a second data element of the message; (vii) and transmitting the message to the issuer.

The resulting technical effect achieved by the systems and methods described herein is at least one of: (i) modifying a transaction message to reflect a merchants active MCCs, which is typically unavailable to an issuer; (ii) reducing the risk of inaccurate authorizations and/or declines of cardholder transactions; and (iii) increasing the accuracy of payment card rewards delivery to a cardholder based on predetermined transactions requirements.

As will be appreciated, based upon the description herein, the technical improvement in populating transaction messages with all MCCs of the transacting merchant as described is a computer-based solution to a technical deficiency or problem that is itself rooted in computer technology (i.e., the problem itself derives from the use of computer technology). More specifically, the technical problems and inefficiencies created by including in a transaction message only a single MCC that is typically hardcoded in a merchant's point of sale (POS) terminal are the result of an implementation and use of computers in payment processing systems and methods. The present disclosure improves upon the conventional methods and systems in the manners described herein. Thus, the inefficiencies or technical problems created by the payment processing systems and methods as described herein are solved by the methods and systems described and particularly claimed.

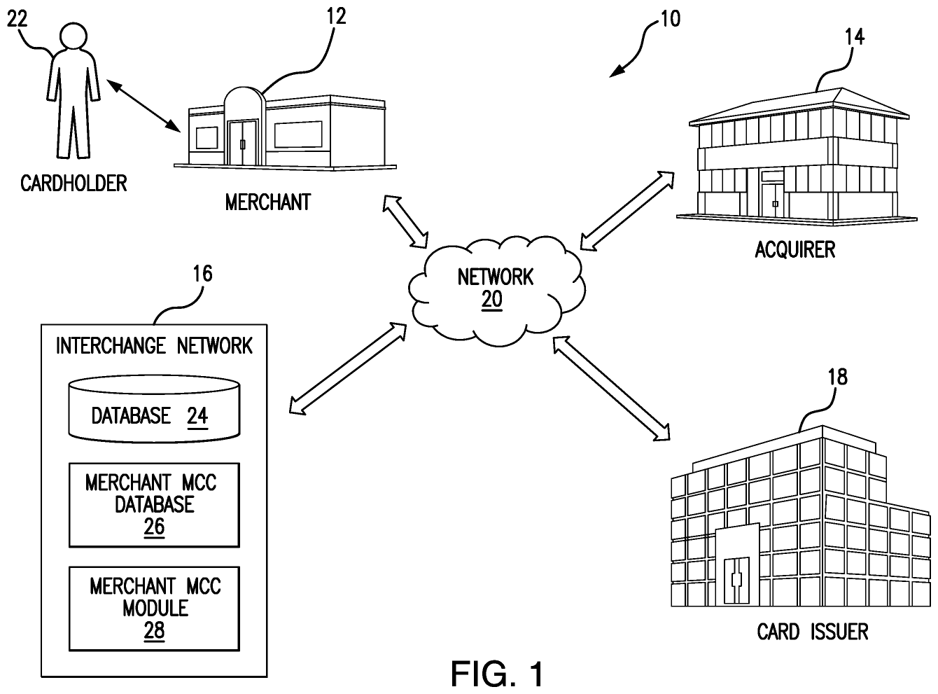

FIG. 1 is a block diagram of an example multi-party payment card network system 10 having a merchant category code (MCC) module 28 (broadly, an MCC system). The payment card network system 10 facilitates providing interchange network services, such as payment authorization, clearing, and settlement services, offered by an interchange network 16. In addition, the payment card network system 10 enables payment card transactions in which merchants 12, acquirers 14, and/or card issuers 18 do not need to have a one-to-one relationship.

In the example embodiment, the payment card network system 10 generally includes the merchants 12, the acquirers 14, the interchange network 16, and the issuers 18, coupled in communication via a network 20. The network 20 includes, for example and without limitation, one or more of a local area network (LAN), a wide area network (WAN) (e.g., the Internet, etc.), a mobile network, a virtual network, and/or any other suitable public and/or private network capable of facilitating communication among the merchants 12, the acquirers 14, the interchange network 16, and/or the issuers 18. In some embodiments, the network 20 may include more than one type of network, such as a private payment transaction network provided by the interchange network 16 to the acquirers 14 and the issuers 18 and, separately, the public Internet, which may facilitate communication between the merchants 12, the interchange network 16, the acquirers 14, and the cardholders 22, etc.

Embodiments described herein may relate to a transaction card system, such as a credit card payment system using the Mastercard® interchange network. (Mastercard is a registered trademark of Mastercard International Incorporated). The Mastercard interchange network is a set of proprietary communications standards promulgated by Mastercard for the exchange of financial transaction data and the settlement of funds between financial institutions that are members of Mastercard. As used herein, financial transaction data includes a unique account number associated with an account holder using a payment card issued by an issuer, purchase data representing a purchase made by the cardholder, including a type of merchant, amount of purchase, date of purchase, and other data, which may be transmitted between any parties of multi-party payment card network system 10.

In a typical transaction card system, a financial institution called the “issuer” issues a transaction card, such as a credit card, to a cardholder 22, who uses the transaction card to tender payment for a purchase from the merchant 12. In the example embodiment, the merchant 12 is typically associated with products, for example, and without limitation, goods and/or services, that are offered for sale and are sold to the cardholders 22. The merchant 12 includes, for example, a physical location and/or a virtual location. A physical location includes, for example, a brick-and-mortar store, etc., and a virtual location includes, for example, an Internet-based store-front.

To accept payment with the transaction card, the merchant 12 must normally establish an account with a financial institution that is part of the payment card network system 10. This financial institution is usually called the “merchant bank,” the “acquiring bank,” or the acquirer 14. When the cardholder 22 tenders payment for a purchase with a transaction card, the merchant 12 requests authorization from the acquirer 14 for the amount of the purchase by transmitting an authorization request message. The request may be performed over the telephone but is usually performed through the use of a point-of-sale (POS) terminal that reads the cardholder's account information from a magnetic stripe, a chip, or embossed characters on the transaction card and communicates the authorization request message electronically to the transaction processing computers of the acquirer 14. Alternatively, the acquirer 14 may authorize a third party to perform transaction processing on its behalf. In this case, the POS terminal will be configured to communicate with the third party. Such a third party is usually called a “merchant processor,” an “acquiring processor,” or a “third party processor.”

Using the interchange network 16, computers of the acquirer 14 or merchant processor will communicate with computers of the issuer 18 to determine whether the cardholder's account is in good standing and whether the purchase is covered by the cardholder's available credit line. Based on these determinations, the request for authorization will be declined or accepted. If the request is accepted, an authorization code is issued to the merchant 12.

When a request for authorization is accepted, the available credit line of the cardholder's account is decreased. Normally, a charge for a payment card transaction is not posted immediately to the cardholder's account because bankcard associations, such as Mastercard, have promulgated rules that do not allow the merchant 12 to charge, or “capture,” a transaction until the purchased goods are shipped or the purchased services are delivered. However, with respect to at least some debit card transactions, a charge may be posted at the time of the transaction. When the merchant 12 ships or delivers the goods or services, the merchant 12 captures the transaction by, for example, appropriate data entry procedures on the POS terminal. This may include bundling of approved transactions daily for standard retail purchases into a clearing batch file. If the cardholder 22 cancels a transaction before it is captured, a “void” is generated. If the cardholder 22 returns goods after the transaction has been captured, a “credit” is generated. The interchange network 16 and/or the issuer 18 stores the transaction information, such as, and without limitation, a type of merchant, a merchant identifier, a location where the transaction was completed, an amount of purchase, and a date and time of the transaction, in a transaction database 24.

After a purchase has been made, a clearing process occurs, including using one or more clearing transaction messages to transfer additional transaction data related to the purchase among the parties to the transaction, such as the acquirer 14, the interchange network 16, and the issuer 18. More specifically, during and/or after the clearing process, additional data, such as a time of purchase, a merchant name, a type of merchant, purchase information, cardholder account information, a type of transaction, itinerary information, information regarding the purchased item and/or service, and/or other suitable information, is associated with a transaction and transmitted between parties to the transaction as transaction data, and may be stored by any of the parties to the transaction.

During authorization and clearing, the transaction information typically includes an MCC being used by the merchant 12 for the transaction. The interchange network 16 includes the MCC module 28 that is configured to analyze various data associated with the payment card transaction and provide various information to one or more parties involved in the payment card transaction, such as the issuer 18. The MCC module 28 is a specially programmed computer system that enables the interchange network 16 to implement an automated process to identify a merchant identifier (ID) of the merchant attempting to authorize the transaction, determine if the merchant is associated with or has multiple active MCCs, and provide a “multiple MCC” indicator and the associated MCCs in the clearing transaction message during the transaction clearing process described herein. The MCC module 28 is specially programmed with a plurality of algorithms that are configured to extract the merchant ID from the authorization request message and/or the clearing transaction message and process the merchant ID using an MCC database 26 to determine if multiple MCCs are associated with the merchant ID. If multiple MCCs are associated with the merchant, the algorithms are further configured to populate or inject the “multiple MCC” indicator and the multiple MCCs into the clearing transaction message.

After a transaction is authorized and cleared, the transaction is settled among the merchant 12, the acquirer 14, and the issuer 18. Settlement refers to the transfer of financial data or funds among the merchant 12, the acquirer 14, and the issuer 18 related to the transaction. Usually, transactions are captured and accumulated into a “batch,” which is settled as a group. More specifically, a transaction is typically settled between the issuer 18 and the interchange network 16, and then between the interchange network 16 and the acquirer 14, and then between the acquirer 14 and the merchant 12.

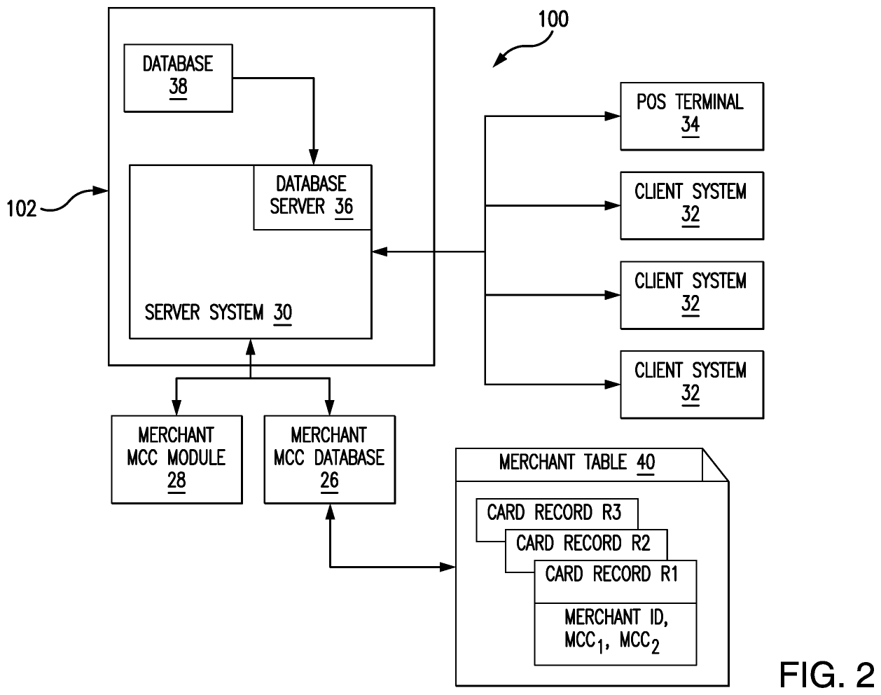

FIG. 2 is a simplified block diagram of an example transaction processing system 102 for providing a “multiple MCC” indicator using the MCC module 28 to issuers 18 in a payment network 100. In some embodiments, the payment network 100 is similar to the payment card network system 10 (shown in FIG. 1). In the example embodiment, the payment network 100 includes a plurality of computing devices connected in accordance with the present disclosure. The payment network 100 includes a server system 30 of the transaction processing system 102 in communication with a plurality of client systems 32 associated with merchant banks, payment networks, and/or issuer banks, such as the acquirer 14, the interchange network 16, and the issuer 18. The server system may also be in communication with one or more point-of-sale (POS) terminals 34 at a merchant location 12 (shown in FIG. 1).

More specifically, in the example embodiment, the transaction processing system 102 includes the server system 30 of, for example, the interchange network 16 (shown in FIG. 1), in communication with the client systems 32 and the POS terminal 34 associated with merchants, merchant banks, payment networks, and/or issuer banks. The server system 30 is also in communication with a plurality of client sub-systems, which are also referred to herein as the client systems 32. In one embodiment, the client systems 32 are computers including a web browser, such that server system 30 is accessible to the client systems 32 using the Internet. The client systems 32 are interconnected to the Internet through one or more of many suitable interfaces including, for example, a network, such as a LAN or WAN, dial-in-connections, cable modems, and/or special high-speed Integrated Services Digital Network (ISDN) lines. The client systems 32 could be any device capable of interconnecting to the Internet including an Internet connected phone, a PDA, or any other suitable web-based connectable equipment.

The POS terminals 34 may be interconnected to the Internet (or any other network that allows the POS terminals 34 to communicate as described herein) through one or more of many suitable interfaces including a network, such as a local area network (LAN) or a wide area network (WAN), dial-in-connections, cable modems, wireless modems, and special high-speed ISDN lines. Each POS terminal 34 is any device capable of interconnecting to the Internet and including an input device capable of reading information from a cardholder's financial transaction card. In some embodiments, the POS terminal 34 may be a cardholder's personal computer, such as when conducting an online purchase through the Internet. As used herein, the terms POS device, POS terminal, and point of interaction device are used broadly, generally, and interchangeably to refer to any device in which a cardholder interacts with a merchant to complete a payment card transaction.

A database server 36 is connected to a database 38, which is configured to store information on a variety of matters, including the transaction data as described below in greater detail. In some embodiments, the database 38 is similar to the transaction database 24 (shown in FIG. 1). In suitable embodiments, the database 38 is a centralized database stored on the server system 30 and can be accessed by potential users at one of the client systems 32 by logging onto the server system 30 through one of the client systems 32. In an alternative embodiment, the database 38 is stored remotely from the server system 30 and may be a distributed or non-centralized database.

In one example embodiment, the database 38 may include a single database having separated sections or partitions or may include multiple databases, each being separate from each other. The database 38 may store transaction data generated as part of sales activities and savings activities conducted over the processing network including data relating to merchants, account holders or customers, issuers, acquirers, savings amounts, savings account information, and/or purchases made. The database 38 may also store account data including at least one of a cardholder name, a cardholder address, an account number, and other account identifier. The database 38 may also store merchant data including a merchant identifier that identifies each merchant registered to use the network, and instructions for settling transactions including merchant bank account information. The database 38 may also store purchase data associated with items being purchased by a cardholder from a merchant, and authorization request data. The database 38 may also store digital wallet data 306, device information, payment card information, and other data involved with providing “multiple MCC” indicators to one or more parties to the transaction, such as the issuer 18.

In the example embodiment, one of the client systems 32 may be associated with the acquirer 14 (shown in FIG. 1) while another one of the client systems 32 may be associated with the issuer 18 (shown in FIG. 1). The POS terminal 34 may be associated with the merchant 12 (shown in FIG. 1) or may be a computer system and/or mobile system used by the cardholder 22 (shown in FIG. 1) making an on-line purchase or payment. The server system 30 may be associated with the interchange network 16 or a payment processor. In the example embodiment, the server system 30 is associated with a financial transaction processing network, such as the interchange network 16, and may be referred to as an interchange computer system. The server system 30 may be used for processing transaction data. In addition, the client systems 32 and the POS terminal 34 may include a computer system associated with at least one of a merchant, an online bank, a bill payment outsourcer, an acquirer bank, an acquirer processor, an issuer bank associated with a transaction card, an issuer processor, a remote payment processing system, and/or a biller.

In the example embodiment, the transaction processing system 102 is in communication with the MCC module 28 and the MCC database 26, which may be associated with the interchange network 16 or with an outside third party in a contractual relationship with the interchange network 16. In some embodiments, the MCC module 28 and the MCC database 26 are in communication with each other and may directly interact during the processing of payment card transactions. In the example embodiment, the MCC module 28 extracts merchant IDs from payment transactions and inserts MCC information in select messages of the payment transactions, and the MCC database 26 provides additional and/or updated MCC information corresponding to the merchant ID associated with the payment transaction. In some embodiments, the MCC module 28 and/or the MCC database 26 are also in communication with a merchant system and/or an issuer system (e.g., the client systems 32) and/or the POS terminal 34 of the merchant. It is noted that the payment network 100 may include more, fewer, or alternative components and/or perform more, fewer, or alternative actions, including those discussed elsewhere herein.

The MCC database 26 includes at least one merchant table 40. The merchant table 40 includes, for example, a plurality of rows or merchant records, such as merchant records R₁, R₂, R₃. Each of the merchant records R₁, R₂, R₃ is associated with a respective merchant ID and includes, for example, a plurality of data fields (e.g., columns of the table). The data fields include, for example, and without limitation, at least a field for active MCCs used by the merchant associated with the merchant ID.

Exemplary Computer Systems

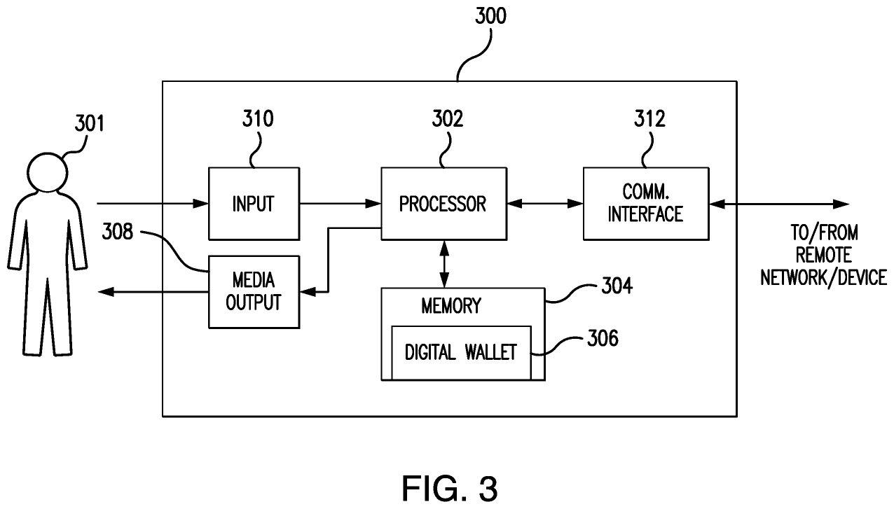

FIG. 3 is an example configuration of a user system 300 operated by a user 301, such as the cardholder 22 (shown in FIG. 1). In some embodiments, the user system 300 is a client system 32 and/or a merchant POS terminal 34. In the example embodiment, the user system 300 includes a processor 302 for executing instructions. In some embodiments, executable instructions are stored in a memory device 304. The processor 302 includes one or more processing units, for example, a multi-core configuration. The memory device 304 is any device allowing information such as the digital wallet data 306, executable instructions, and/or written works to be stored and retrieved. The memory device 304 includes one or more computer readable media.

The user system 300 also includes at least one media output component 308 for presenting information to the user 301. The media output component 308 is any component capable of conveying information to the user 301. In some embodiments, the media output component 308 includes an output adapter such as a video adapter and/or an audio adapter. An output adapter is operatively coupled to the processor 302 and operatively connectable to an output device such as a display device, a liquid crystal display (LCD), organic light emitting diode (OLED) display, or “electronic ink” display, or an audio output device, a speaker, or headphones.

In some embodiments, the user system 300 includes an input device 310 for receiving input from the user 301. The input device 310 may include, for example, one or more of a touch sensitive panel, a touch pad, a touch screen, a stylus, a gyroscope, an accelerometer, a position detector, a keyboard, a pointing device, a mouse, and an audio input device. A single component such as a touch screen may function as both an output device of the media output component 308 and the input device 310. In addition, where the user system 300 is a POS terminal 34, the input device 310 may further include, for example, one or more of a magnetic stripe reader and a payment card chip reader.

The user system 300 may also include one or more communication interfaces 312, which is communicatively connectable to a remote device such as the server system 30 and/or the POS terminal 34 (shown in FIG. 2). The communication interface 312 may include, for example, one or more of a wired or wireless network adapter or a wireless data transceiver for use with Bluetooth communication, radio frequency communication, near field communication (NFC), and/or with a mobile phone network, Global System for Mobile communications (GSM), 3G, or other mobile data network, and/or Worldwide Interoperability for Microwave Access (WiMax) and the like. In addition, where the user system 300 is a POS terminal 34, the communication interface 312 may also function as an input device, such as the input device 310. For example, an NFC communication interface can function as an input device for receiving the account information from an NFC-enabled payment card.

Stored in the memory device 304 are, for example, computer readable instructions for providing a user interface to the user 301 via the media output component 308 and, optionally, receiving and processing input from the input device 310. A user interface may include, among other possibilities, a web browser and a client application. Web browsers enable users, such as the user 301, to display and interact with media and other information typically embedded on a web page or a website from the server system 30. A client application allows the user 301 to interact with a server application from the server system 30.

In the example embodiment, the user system 300 is a user computing device from which the user 301 may engage (directly or indirectly) with a digital wallet 306, an online merchant (e.g., the merchant 12 shown in FIG. 1), an interchange network (e.g., the interchange network 16 shown in FIG. 1), and an issuer of a payment card (e.g., the issuer 18 shown in FIG. 1) to perform a payment transaction that undergoes a merchant advice code population process.

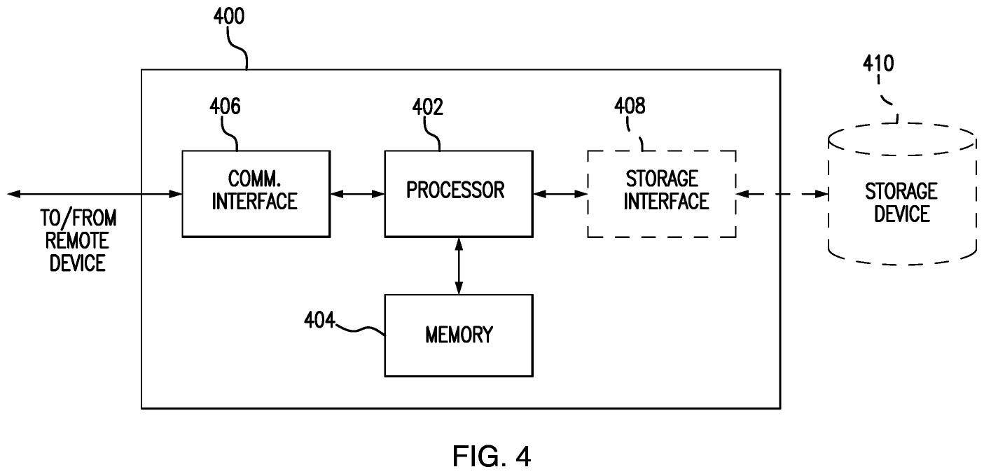

FIG. 4 is an example configuration of a server system 400, such as the server system 30 (shown in FIG. 2). The server system 400 includes, but is not limited to, the transaction database 24 (shown in FIG. 1), the MCC module 28, and/or the MCC database 26. In the example embodiment, the server system 400 includes a processor 402 for executing instructions. The instructions may be stored in a memory device 404, for example. The processor 402 includes one or more processing units (e.g., in a multi-core configuration) for executing the instructions. The instructions may be executed within a variety of different operating systems on the server system 400, such as UNIX, LINUX, Microsoft Windows®, etc. More specifically, the instructions may cause various data manipulations on data stored in a storage device 410 (e.g., create, read, update, and delete procedures). It should also be appreciated that upon initiation of a computer-based method, various instructions may be executed during initialization. Some operations may be required to perform one or more processes described herein, while other operations may be more general and/or specific to a programming language (e.g., C, C#, C++, Java, or other suitable programming languages, etc.).

The processor 402 is operatively coupled to a communication interface 406 such that the server system 400 can communicate with a remote device such as a user system 300 (shown in FIG. 3) or another server system 400. For example, the communication interface 406 may receive communications from a client system 32 via the Internet, as illustrated in FIG. 2.

The processor 402 is operatively coupled to the storage device 410. The storage device 410 is any computer-operated hardware suitable for storing and/or retrieving data. In some embodiments, the storage device 410 is integrated in the server system 400. In other embodiments, the storage device 410 is external to the server system 400 and is similar to the transaction database 24 and/or the MCC database 26. For example, the server system 400 may include one or more hard disk drives as the storage device 410. In other embodiments, the storage device 410 is external to the server system 400 and may be accessed by a plurality of server systems 400. For example, the storage device 410 may include multiple storage units such as hard disks or solid-state disks in a redundant array of inexpensive disks (RAID) configuration. The storage device 410 may include a storage area network (SAN) and/or a network attached storage (NAS) system.

In some embodiments, the processor 402 is operatively coupled to the storage device 410 via a storage interface 408. The storage interface 408 is any component capable of providing the processor 402 with access to the storage device 410. The storage interface 408 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing the processor 402 with access to the storage device 410.

The memory device 404 includes, but is not limited to, random access memory (RAM) such as dynamic RAM (DRAM) or static RAM (SRAM), read-only memory (ROM), erasable programmable read-only memory (EPROM), electrically erasable programmable read-only memory (EEPROM), and non-volatile RAM (NVRAM). The above memory types are exemplary only and are thus not limiting as to the types of memory usable for storage of a computer program.

In the example embodiment, the server system 400 is a merchant MCC processing system in communication with one or more of the issuer 18, the merchant 12, and the acquirer 14 during a payment card transaction, such as a payment transaction involving the digital wallet 306 (shown in FIG. 3) of a user, such as the cardholder 22 (shown in FIG. 1). The server system 400 checks for active MCCs used by the transacting merchant and provides a multiple MCC indicator and the associated MCCs to an issuer associated with the account used to perform the payment transaction.

Exemplary MCC Populating System

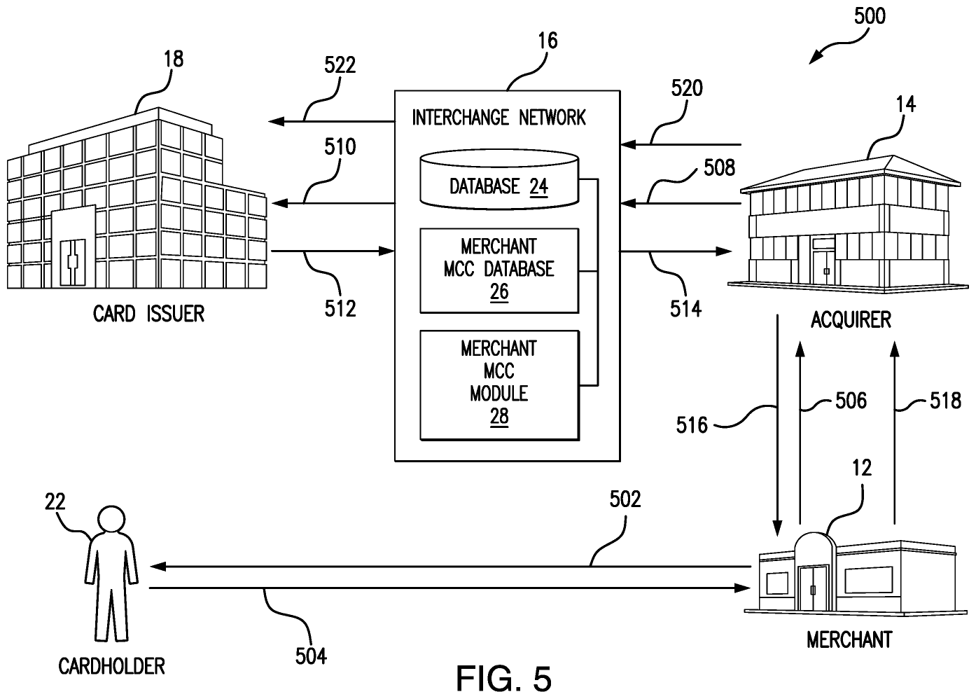

FIG. 5 is a schematic diagram of the payment card network system 10 showing data flow among the parties during a payment transaction. The cardholder 22 initiates the payment transaction using for example, and without limitation, a payment card or a computing device containing a digital wallet, such as the user system 300 (shown in FIG. 3) to transact with the merchant 12 to purchase goods and/or services.

In the example embodiment, the merchant 12 includes a merchant computer device, such as the POS terminal 34 (shown in FIG. 2), and the cardholder 22 has a computing device containing a digital wallet, such as the user system 300 (shown in FIG. 3). When the cardholder 22 selects to initiate a transaction with the merchant 12, the merchant 12 transmits purchase data 502, for example, and without limitation, to the POS terminal 34 (shown in FIG. 2) and/or by the Internet or by radio transmission to the user's computing device. The purchase data 502 includes information related to goods and/or services provided by the merchant 12. For example, and without limitation, in one embodiment, the merchant 12 is associated with a grocery store having an in-store pharmacy and the purchase data 502 is product or service information such as, for example, a transaction total for groceries. The cardholder 22 transmits payment data 504 to the merchant 12 after receiving the purchase data 502 from the merchant 12 (e.g., at the POS terminal 34 or the user's computing device). The cardholder 22 may transmit the payment data 504 wirelessly, for example, via the user's computing device to the merchant 12, i.e., to the POS terminal 34, or physically via a swipe or dip of a payment card at the POS terminal 34. The payment data 504 includes transaction information responsive to the purchase data 502, i.e., the payment data 504 includes payment account data (i.e., data read from the payment card magnetic stripe or chip) or a payment credential (i.e., the digital wallet data 306 shown in FIG. 3), and in some instances, indicates a purchased item identifier associated with the goods and/or services the cardholder 22 would like to purchase from the merchant 12.

The merchant 12 receives the payment data 504 and generates a payment authorization request message 506 having a merchant ID included therein. It is noted that the messages within an interchange network such the interchange network 16, may, in at least some instances, conform to the International Organization for Standardization (ISO) Standard 8583, Financial transaction card originated messages—Interchange message specifications, which is the ISO standard for systems that exchange electronic transactions made by cardholders using payment cards. In the example embodiment, the payment authorization request message 506 can be an ISO 8583 message type identifier (MTI) “0100” message.

The payment authorization request message 506 (i.e., the “0100” message) is transmitted to the acquirer 14 for processing and further transmitted to the issuer 18 for approval. For example, the acquirer 14 communicates with and transmits the “0100” message to the interchange network 16, as indicated by arrow 508. In one suitable embodiment, the interchange network 16, using the MCC module 28, detects the merchant ID from within a data element of the “0100” message and checks it against the MCC database 26, as is described herein, to determine whether the merchant ID has multiple MCCs associated therewith. If there are multiple MCCs associated with the merchant ID, the interchange network 16 flags the transaction, for example, by placing a “multiple MCC” indicator in memory, such as the database 38, and waits to receive a corresponding clearing transaction message from the acquirer 14. The interchange network 16 forwards the “0100” message to the issuer 18, as indicated by arrow 510 to determine whether the cardholder 22 is authorized to make the transaction.

The issuer 18 transmits a payment authorization response message 512 back to the interchange network 16 after approval or disapproval of the authorization request (i.e., the “0100” message). In the example embodiment, the payment authorization response message 512 can be an ISO 8583 message type identifier (MTI) “0110” message. If the issuer 18 disapproves or denies the transaction, the issuer may populate the merchant advice code portion of the payment authorization response message 512 with information as to why the transaction was disapproved. For example, if the account and/or payment card used by the cardholder 22 has been issued a new account number or expiration date, the payment may be declined because the authorization request is against the old account data.

The interchange network 16 then transmits the “0110” payment authorization response message to the acquirer 14, as indicated by arrow 514. The acquirer transmits the “0110” payment authorization response message to the merchant 12, as indicated by arrow 516. After receiving the “0110” payment authorization response message, the merchant 12 completes the transaction if approved or cancels the transaction if disapproved.

At selected periods (e.g., at the end of a business day), the merchant 12 initiates a clearing process to clear and settle its transactions. For example, and typically in a batch mode, clearing is initiated via a clearing transaction message, as indicated by reference character 518. In the exemplary embodiment, the clearing transaction message includes an ISO 8583 clearing transaction message of message type identifier (MTI) “1240” having a DE24 function code value of 200 for a first presentment. The acquirer 14 communicates with and transmits the clearing transaction message, i.e., the “1240” message, to the interchange network 16, as indicated by reference character 520.

After the clearing transaction message “1240” is received from the acquirer 14, the interchange network 16, using the MCC module 28, detects the merchant ID associated with each transaction in the batch. In one embodiment, the MCC module 28 checks to see if a “multiple MCC” indicator was previously stored, for example, in the database 38. If not, the message is not edited to include additional MCC information. If an indicator is present, the MCC module 28 retrieves the merchant table 40 from the MCC database 26 and retrieves from the merchant table 40 the merchant record, such as one of the merchant records R₁, R₂, R₃, that corresponds to the merchant ID. The transaction message may then be enriched with the multiple MCC information before being passed on to the issuer 18, as indicated by arrow 522. Alternatively, in embodiments where no “multiple MCC” indicator is being stored based on the authorization message, the MCC module 28 retrieves the merchant table 40 from the MCC database 26 based on the detected merchant ID and retrieves from the merchant table 40 the merchant record, such as one of the merchant records R₁, R₂, R₃, that corresponds to the merchant ID. If the merchant record indicates multiple MCCs are associated with the merchant ID, the transaction message may then be enriched with the multiple MCC information before being passed on to the issuer 18, as indicated by arrow 522.

Exemplary Computer-Implemented Methods

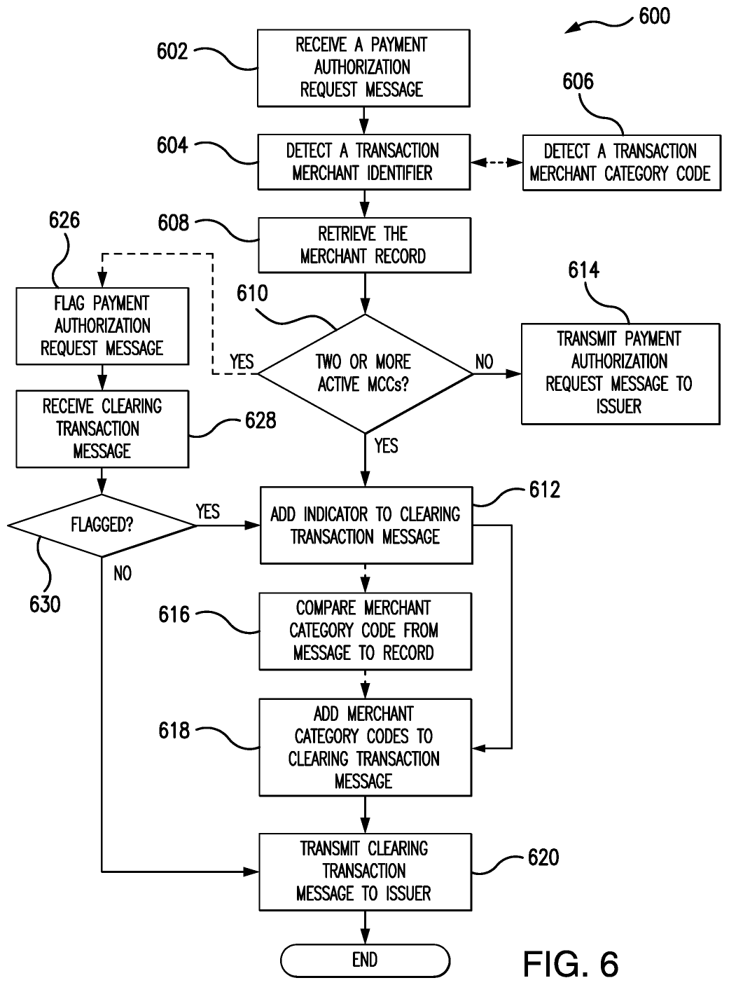

FIG. 6 is a flowchart illustrating an exemplary computer-implemented method 600 for identifying multiple MCCs associated with a merchant, such as the merchant 12 (shown in FIG. 1), processing a transaction with a user, such as the cardholder 22 (shown in FIG. 1), in accordance with one embodiment of the present disclosure. The operations described herein may be performed in the order shown in FIG. 6 or may be performed in a different order. Furthermore, some operations may be performed concurrently as opposed to sequentially. In addition, some operations may be optional.

The computer-implemented method 600 is described below, for ease of reference, as being executed by exemplary devices and components introduced with the embodiments illustrated in FIGS. 1-5. In one embodiment, the computer-implemented method 600 may be implemented by the interchange network 16 (shown in FIG. 1) using a computing device, such as the server system 400 (shown in FIG. 4). In the exemplary embodiment, the computer-implemented method 600 relates to identifying multiple MCCs associated with a merchant processing a transaction. While operations within the computer-implemented method 600 are described below regarding the server systems 400, the computer-implemented method 600 may be implemented using any other computing devices and/or systems through the utilization of processors, transceivers, hardware, software, firmware, or combinations thereof. A person having ordinary skill will also appreciate that responsibility for all or some of such actions may be distributed differently among such devices or other computing devices without departing from the spirit of the present disclosure.

One or more computer-readable medium(s) may also be provided. The computer-readable medium(s) may include one or more executable programs stored thereon, wherein the program(s) instruct one or more processors or processing units to perform all or certain of the steps outlined herein. The program(s) stored on the computer-readable medium(s) may instruct the processor or processing units to perform additional, fewer, or alternative actions, including those discussed elsewhere herein.

In the exemplary embodiment, at operation 602, the interchange network 16 receives a payment authorization request message 506 for a transaction being processed by a merchant, such as the merchant 12 (shown in FIG. 1). As described herein, the payment authorization request message 506 is an ISO 8583 message type identifier (MTI) “0100” message. The payment authorization request message 506 preferably includes at least a transaction identifier, a transaction merchant ID, a transaction MCC, and payment account data associated with an issuer, such as the issuer 18. A transaction identifier, for example, and without limitation, may include one or more of an account number or payment card number (sometimes referred to as a primary account number or “PAN”), a time and date of the transaction, a location, the merchant ID, the transaction MCC, and the like.

At operation 604, the MCC module 28 detects the transaction merchant ID that is embedded in the payment authorization request message 506. For example, and without limitation, the MCC module 28 may parse the payment authorization request message 506 and extract therefrom the transaction merchant ID. Optionally, at operation 606, the MCC module 28 detects a transaction MCC that is embedded in the payment authorization request message 506. As with the merchant ID described above, the MCC module 28 may parse the payment authorization request message 506 and extract therefrom the transaction MCC.

At operation 608, the MCC module 28 retrieves from the merchant table 40 a merchant record, such as one of the merchant records R₁, R₂, or R₃, that has a merchant ID that corresponds to the detected transaction merchant ID. For example, the MCC module 28 performs a lookup operation using the detected merchant ID to match the detected merchant ID to a merchant ID of the merchant records R₁, R₂, or R₃. After finding a matching merchant record, at operation 610, the MCC module 28 determines whether the retrieved merchant record includes two or more active MCCs listed therein. In particular, the MCC module 28 identifies a data field that includes a list of active MCCs used by the merchant associated with the detected merchant ID.

If the retrieved merchant record includes two or more active MCCs, at operation 612 the MCC module 28 adds a multiple MCC indicator within a new first data element of a clearing transaction message, such as the clearing transaction message 520, that corresponds to the payment authorization request message 506. As described herein, the clearing transaction message 520 is an ISO 8583 message type identifier (MTI) “1240” message. The indicator provides an indication to the issuer 18 that the transaction merchant ID is associated with two or more MCCs. The multiple MCC indicator my be any type of indicator inserted into the clearing transaction message 520 that enables the clearing transaction message to function as described herein. For example, the indicator may be a numerical indicator, such as “01,” added to the new first data element of the clearing transaction message 520. If the merchant record does not include more than one active MCC, the transaction is processed business-as-usual (BAU) by the interchange network 16 by transmitting the payment authorization request message 506 to the issuer 18 as indicated at operation 614.

Optionally, in operation 616, for embodiments where the MCC module 28 detects a transaction MCC in the payment authorization request message 506, as described in optional operation 606, and the MCC module 28 determines that the retrieved merchant record includes two or more active MCCs, as described in operation 610, the MCC module 28 compares the detected transaction MCC to the two or more active MCCs identified in the merchant record. The MCC module 28 then identifies the MCCs that are different than the detected transaction MCC and may store them temporarily in memory, such as in memory device 404.

At operation 618, the MCC module 28 adds the list of active MCCs to the clearing transaction message 520. In particular, the MCC module 28 adds the active MCCs to a new second data element of the clearing transaction message 520. In embodiments where the MCC module 28 identified the MCCs that were different than the detected transaction MCC, the MCC module 28 may retrieve the list of different MCCs from memory and add them to the second data element of the clearing transaction message 520. In some embodiments, the MCC module 28 may add the two or more active MCCs to the clearing transaction message 520 in one of numerical order or reverse numerical order.

In some embodiments, the merchant record may include a transaction count value indicating a number of transactions processed by the merchant using a respective one of the active MCCs over a predetermined period. For example, if a merchant processed five (5) transactions under MCC 5912 (Drug Stores and Pharmacies) and twenty (20) transactions under MCC 5411 (Grocery Stores, Supermarkets), the merchant record includes such count values with the identified respective MCC. As such, the MCC module 28 may add the two or more active MCCs to the clearing transaction message 520 in one of numerical order or reverse numerical order according to the transaction count value.

At operation 620, the MCC module 28 transmits the clearing transaction message to the issuer associated with the payment account data, such as the issuer 18 (indicated by reference character 522 in FIG. 5). The issuer 18 is then notified via the two (2) new data elements that the particular merchant associated with the transaction uses more than one MCC when processing transactions. As such, the issuer 18 is able to further determine how to treat the transaction based on such MCCs. For example, in one embodiment, the issuer 18 may be able to provide rewards to a cardholder, such as the cardholder 22, for a purchase that may not otherwise qualify under the MCC used in the transaction. An example may be when a cardholder 22 purchases items available for a reward from a counter at the merchant that is programmed with a different MCC, such as a pharmacy counter at a grocery store. In addition, knowing the various active MCCs used by the merchant enables the issuer to block and/or allow transactions based on an active MCC other than the one used to process the transaction, and/or determine a merchant fraud score on a riskier MCC than the merchant uses.

In one embodiment, optionally, if the retrieved merchant record includes two or more active MCCs, at optional operation 622 the MCC module 28 may flag the payment authorization request message 506. For example, as described herein, the MCC module 28 may place a “multiple MCC” indicator in memory, such as the database 38, and waits to receive the corresponding clearing transaction message 520 from the acquirer 14. At operation 624, the MCC module 28 receives the clearing transaction message 520 corresponding to the payment authorization request message 506 and determines whether the corresponding payment authorization request message 506 is flagged at operation 626.

If the payment authorization request message 506 is flagged, for example in database 38, the process continues at operation 612. However, if the payment authorization request message 506 is not flagged, then no further multiple MCC processing is performed by the MCC module 28 and the transaction is processed business-as-usual (BAU) by the interchange network 16 and proceeds at operation 620.

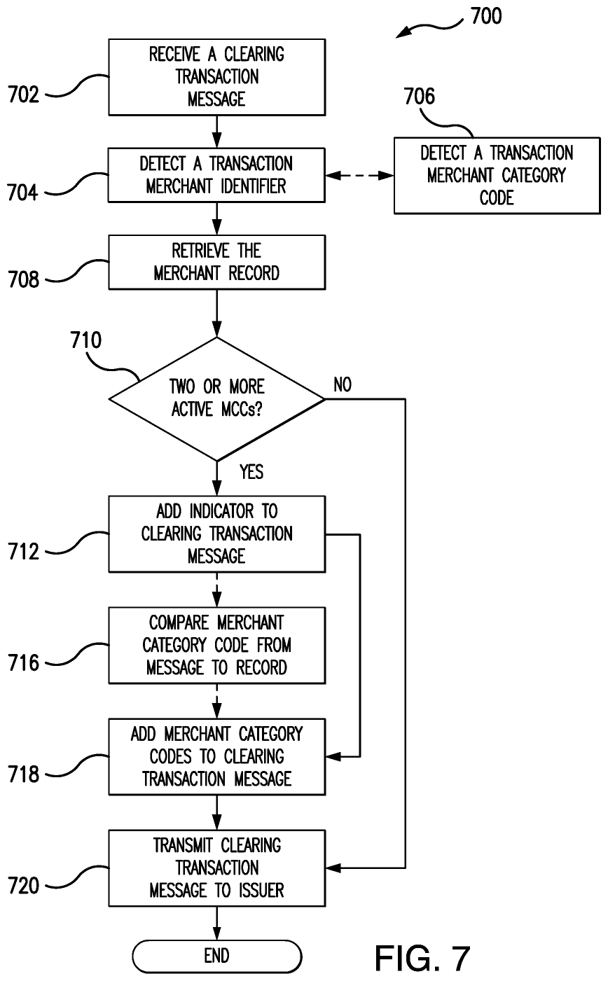

FIG. 7 is a flowchart illustrating an exemplary computer-implemented method 700 for identifying multiple MCCs associated with a merchant, such as the merchant 12 (shown in FIG. 1), processing a transaction with a user, such as the cardholder 22 (shown in FIG. 1), in accordance with one embodiment of the present disclosure. The operations described herein may be performed in the order shown in FIG. 7 or may be performed in a different order. Furthermore, some operations may be performed concurrently as opposed to sequentially. In addition, some operations may be optional.

The computer-implemented method 700 is described below, for ease of reference, as being executed by exemplary devices and components introduced with the embodiments illustrated in FIGS. 1-5. In one embodiment, the computer-implemented method 700 may be implemented by the interchange network 16 (shown in FIG. 1) using a computing device, such as the server system 400 (shown in FIG. 4). In the exemplary embodiment, the computer-implemented method 700 relates to identifying multiple MCCs associated with a merchant processing a transaction. While operations within the computer-implemented method 700 are described below regarding the server systems 400, the computer-implemented method 700 may be implemented using any other computing devices and/or systems through the utilization of processors, transceivers, hardware, software, firmware, or combinations thereof. A person having ordinary skill will also appreciate that responsibility for all or some of such actions may be distributed differently among such devices or other computing devices without departing from the spirit of the present disclosure.

One or more computer-readable medium(s) may also be provided. The computer-readable medium(s) may include one or more executable programs stored thereon, wherein the program(s) instruct one or more processors or processing units to perform all or certain of the steps outlined herein. The program(s) stored on the computer-readable medium(s) may instruct the processor or processing units to perform additional, fewer, or alternative actions, including those discussed elsewhere herein.

In the exemplary embodiment, at operation 702, the interchange network 16 receives the clearing transaction message 520 for a transaction previously processed by a merchant, such as the merchant 12 (shown in FIG. 1). The clearing transaction message 520 includes at least a transaction identifier, a transaction merchant ID, a transaction MCC, and payment account data associated with an issuer, such as the issuer 18.

At operation 704, the MCC module 28 detects the transaction merchant ID that is embedded in the clearing transaction message 520. For example, and without limitation, the MCC module 28 parses the clearing transaction message 520 and extracts therefrom the transaction merchant ID. Optionally, at operation 706, the MCC module 28 detects a transaction MCC that is embedded in the clearing transaction message 520. As with the merchant ID described above, the MCC module 28 parses the clearing transaction message 520 and extracts therefrom the transaction MCC.

At operation 708, the MCC module 28 retrieves from the merchant table 40 a merchant record, such as one of the merchant records R₁, R₂, or R₃, that has a merchant ID that corresponds to the detected transaction merchant ID. For example, the MCC module 28 performs a lookup operation using the detected merchant ID to match the detected merchant ID to a merchant ID of the merchant records R₁, R₂, or R₃. After finding a matching merchant record, at operation 710, the MCC module 28 determines whether the retrieved merchant record includes two or more active MCCs listed therein. In particular, the MCC module 28 identifies a data field that includes a list of active MCCs used by the merchant associated with the detected merchant ID.

If the retrieved merchant record includes two or more active MCCs, at operation 712 the MCC module 28 adds a multiple MCC indicator within a new first data element of the clearing transaction message 520, which corresponds to a previously received payment authorization request message, such as the payment authorization request message 506 (shown in FIG. 5). The indicator provides an indication to the issuer 18 that the transaction merchant ID is associated with two or more MCCs. The multiple MCC indicator my be any type of indicator inserted into the clearing transaction message 520 that enables the clearing transaction message to function as described herein. For example, the indicator may be a numerical indicator, such as “01,” added to the new first data element of the clearing transaction message 520. If the merchant record does not include more than one active MCC, the transaction is processed business-as-usual (BAU) by the interchange network 16 by transmitting the clearing transaction message 520 to the issuer 18 as indicated at operation 720.

Optionally, in operation 716, for embodiments where the MCC module 28 detects a transaction MCC in the clearing transaction message 520, as described in optional operation 706, and the MCC module 28 determines that the retrieved merchant record includes two or more active MCCs, as described in operation 710, the MCC module 28 compares the detected transaction MCC to the two or more active MCCs identified in the merchant record. The MCC module 28 then identifies the MCCs that are different than the detected transaction MCC and may store them temporarily in memory, such as in memory device 404.

At operation 718, the MCC module 28 adds the list of active MCCs to the clearing transaction message 520. In particular, the MCC module 28 adds the active MCCs to a new second data element of the clearing transaction message 520. In embodiments where the MCC module 28 identified the MCCs that were different than the detected transaction MCC, the MCC module 28 may retrieve the list of different MCCs from memory and add them to the second data element of the clearing transaction message 520. In some embodiments, the MCC module 28 may add the two or more active MCCs to the clearing transaction message 520 in one of numerical order or reverse numerical order.

In some embodiments, the merchant record includes a transaction count value indicating a number of transactions processed by the merchant 12 using a respective one of the active MCCs over a predetermined period. As such, the MCC module 28 adds the two or more active MCCs to the clearing transaction message 520 in one of numerical order or reverse numerical order according to the transaction count value.

At operation 720, the MCC module 28 transmits the clearing transaction message to the issuer associated with the payment account data, such as the issuer 18 (indicated by reference character 522 in FIG. 5). The issuer 18 is then notified via the two (2) new data elements that the particular merchant associated with the transaction uses more than one MCC when processing transactions. As such, the issuer 18 is able to further determine how to treat the transaction based on such MCCs, as described further above.

### ADDITIONAL CONSIDERATIONS

In this description, references to “one embodiment,” “an embodiment,” or “embodiments” mean that the feature or features being referred to are included in at least one embodiment of the technology. Separate references to “one embodiment,” “an embodiment,” or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments but is not necessarily included. Thus, the current technology can include a variety of combinations and/or integrations of the embodiments described herein.

Although the present application sets forth a detailed description of numerous different embodiments, it should be understood that the legal scope of the description is defined by the words of the claims set forth at the end of this patent and equivalents. The detailed description is to be construed as exemplary only and does not describe every possible embodiment because describing every possible embodiment would be impractical. Numerous alternative embodiments may be implemented, using either current technology or technology developed after the filing date of this patent, which would still fall within the scope of the claims.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order recited or illustrated, unless so stated and/or except as will be readily apparent to those skilled in the art. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of routines, subroutines, applications, or instructions. These may constitute either software (e.g., code embodied on a machine-readable medium or in a transmission signal) or hardware. In hardware, the routines, etc., are tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as computer hardware that operates to perform certain operations as described herein.

In various embodiments, computer hardware, such as a processor, may be implemented as special purpose or as general purpose. For example, the processor may comprise dedicated circuitry or logic that is permanently configured, such as an application-specific integrated circuit (ASIC), or indefinitely configured, such as a field-programmable gate array (FPGA), to perform certain operations. The processor may also comprise programmable logic or circuitry (e.g., as encompassed within a general-purpose processor or other programmable processor) that is temporarily configured by software to perform certain operations. It will be appreciated that the decision to implement the processor as special purpose, in dedicated and permanently configured circuitry, or as general purpose (e.g., configured by software) may be driven by cost and time considerations.

Accordingly, the term “processor” or equivalents should be understood to encompass a tangible entity, be that an entity that is physically constructed, permanently configured (e.g., hardwired), or temporarily configured (e.g., programmed) to operate in a certain manner or to perform certain operations described herein. Considering embodiments in which the processor is temporarily configured (e.g., programmed), each of the processors need not be configured or instantiated at any one instance in time. For example, where the processor comprises a general-purpose processor configured using software, the general-purpose processor may be configured as respective different processors at different times. Software may accordingly configure the processor to constitute a particular hardware configuration at one instance of time and to constitute a different hardware configuration at a different instance of time.

Computer hardware components, such as transceiver elements, memory elements, processors, and the like, may provide information to, and receive information from, other computer hardware components. Accordingly, the described computer hardware components may be regarded as being communicatively coupled. Where multiple of such computer hardware components exist contemporaneously, communications may be achieved through signal transmission (e.g., over appropriate circuits and buses) that connect the computer hardware components. In embodiments in which multiple computer hardware components are configured or instantiated at different times, communications between such computer hardware components may be achieved, for example, through the storage and retrieval of information in memory structures to which the multiple computer hardware components have access. For example, one computer hardware component may perform an operation and store the output of that operation in a memory device to which it is communicatively coupled. A further computer hardware component may then, at a later time, access the memory device to retrieve and process the stored output. Computer hardware components may also initiate communications with input or output devices, and may operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or more processors or processor-implemented hardware modules. The performance of certain of the operations may be distributed among the one or more processors, not only residing within a single machine, but deployed across a number of machines. In some example embodiments, the processors may be located in a single location (e.g., within a home environment, an office environment or as a server farm), while in other embodiments the processors may be distributed across a number of locations.

Unless specifically stated otherwise, discussions herein using words such as “processing,” “computing,” “calculating,” “determining,” “presenting,” “displaying,” or the like may refer to actions or processes of a machine (e.g., a computer with a processor and other computer hardware components) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus.

Although the disclosure has been described with reference to the embodiments illustrated in the attached drawing figures, it is noted that equivalents may be employed, and substitutions made herein, without departing from the scope of the disclosure as recited in the claims.

Having thus described various embodiments of the disclosure, what is claimed as new and desired to be protected by Letters Patent includes the following:

What is claimed is:

1. A system for identifying multiple merchant category codes associated with a merchant processing a transaction, said system comprising:
a database comprising a merchant table having one or more merchant records therein, each merchant record comprising a unique merchant identifier associated with a distinct merchant and one or more active merchant category codes associated with the unique merchant identifier; and
a server coupled to the database, the server comprising a processor programmed to:
receive a clearing transaction message for the transaction, the clearing transaction message having payment account data associated with an issuer;
detect a transaction merchant identifier that is included in the clearing transaction message;
retrieve from the merchant table the merchant record having the unique merchant identifier that corresponds to the detected transaction merchant identifier;
determine whether the retrieved merchant record includes two or more active merchant category codes;
if the retrieved merchant record includes two or more active merchant category codes, add an indicator within a first data element of the clearing transaction message, the indicator providing indication that the transaction merchant identifier is associated with two or more merchant category codes;
add the two or more active merchant category codes to a second data element of the clearing transaction message; and
transmit the clearing transaction message to the issuer associated with the payment account data.

2. The system in accordance with claim 1,
said operation of adding the two or more active merchant category codes further comprising adding the two or more active merchant category codes in one of the following: numerical order and reverse numerical order.

3. The system in accordance with claim 1,
said each merchant record further comprising a transaction count value associated with each of the one or more active merchant category codes, the transaction count value indicating a number of transactions processed by the merchant using the respective active merchant category code over a predetermined period,
said operation of adding the two or more active merchant category codes further comprising adding the two or more active merchant category codes according to the transaction count value in one of the following: numerical order and reverse numerical order.

4. The system in accordance with claim 1,
said processor further programmed to detect a transaction merchant category code that is included in the clearing transaction message, and
compare the detected transaction merchant category code to the two or more active merchant category codes,
said operation of adding the two or more active merchant category codes further comprising, based on the comparison, adding the two or more active merchant category codes that are different than the detected transaction merchant category code to the second data element.

5. The system in accordance with claim 4,
said each merchant record further comprising a transaction count value associated with each of the one or more active merchant category codes, the transaction count value indicating a number of transactions processed by the merchant using the respective active merchant category code over a predetermined period,
said operation of adding the two or more active merchant category codes that are different than the detected transaction merchant category code further comprising adding the two or more active merchant category codes that are different than the detected transaction merchant category code according to the transaction count in one of the following: numerical order and reverse numerical order.

6. The system in accordance with claim 4,
said operation of adding the two or more active merchant category codes that are different than the detected transaction merchant category code further comprising adding the two or more active merchant category codes that are different than the detected transaction merchant category code in one of the following: numerical order and reverse numerical order.

7. The system in accordance with claim 1,
the clearing transaction message comprising an International Organization for Standardization (ISO) 8583 message.

8. The system in accordance with claim 7,
said operation of detecting the transaction merchant identifier comprises detecting the transaction merchant identifier from within a third data element of the ISO 8583 message.

9. The system in accordance with claim 1,
said operation of receiving the clearing transaction message comprising receiving a clearing batch file containing a plurality of clearing transaction messages.

10. A system for identifying multiple merchant category codes associated with a merchant processing a transaction, said system comprising:
a database comprising a merchant table having one or more merchant records therein, each merchant record comprising a unique merchant identifier associated with a distinct merchant and one or more active merchant category codes associated with the unique merchant identifier; and
a server coupled to the database, the server comprising a processor programmed to:
receive a payment authorization request message for the transaction, the payment authorization request message having payment account data associated with an issuer and a merchant identifier;
detect a transaction merchant identifier that is included in the payment authorization request message;
retrieve from the merchant table the merchant record having the unique merchant identifier that corresponds to the detected transaction merchant identifier;
determine whether the retrieved merchant record includes two or more active merchant category codes;
if the retrieved merchant record includes two or more active merchant category codes, add an indicator within a first data element of a clearing transaction message corresponding to the payment authorization request message, the indicator providing indication that the transaction merchant identifier is associated with two or more merchant category codes;
add the two or more active merchant category codes to a second data element of the clearing transaction message; and
transmit the clearing transaction message to the issuer associated with the payment account data.

11. The system in accordance with claim 10,
said each merchant record further comprising a transaction count value associated with each of the one or more active merchant category codes, the transaction count value indicating a number of transactions processed by the merchant using the respective active merchant category code over a predetermined period,
said operation of adding the two or more active merchant category codes further comprising adding the two or more active merchant category codes according to the transaction count value in one of the following: numerical order and reverse numerical order.

12. The system in accordance with claim 10,
said operation of adding the two or more active merchant category codes further comprising adding the two or more active merchant category codes in one of the following: numerical order and reverse numerical order.

13. The system in accordance with claim 10,
said processor further programmed to detect a transaction merchant category code that is included in the payment authorization request message; and
compare the detected transaction merchant category code to the two or more active merchant category codes,
said operation of adding the two or more active merchant category codes further comprising, based on the comparison, adding the two or more active merchant category codes that are different than the detected transaction merchant category code to the second data element.

14. The system in accordance with claim 13,
said each merchant record further comprising a transaction count value associated with each of the one or more active merchant category codes, the transaction count value indicating a number of transactions processed by the merchant using the respective active merchant category code over a predetermined period,
said operation of the two or more active merchant category codes that are different than the detected transaction merchant category code further comprising adding the two or more active merchant category codes that are different than the detected transaction merchant category code according to the transaction count value in one of the following: numerical order and reverse numerical order.

15. The system in accordance with claim 13,
said operation of adding the two or more active merchant category codes that are different than the detected transaction merchant category code further comprising adding the two or more active merchant category codes that are different than the detected transaction merchant category code in one of the following: numerical order and reverse numerical order.

16. The system in accordance with claim 10,
the clearing transaction message comprising an International Organization for Standardization (ISO) 8583 message.

17. The system in accordance with claim 16,
said operation of detecting the transaction merchant identifier comprises detecting the transaction merchant identifier from within a third data element of the ISO 8583 message.

18. The system in accordance with claim 10,
said processor further programmed to:
if the retrieved merchant record includes two or more active merchant category codes, flag the payment authorization request message;
receive the clearing transaction message corresponding to the payment authorization request message; and
if the corresponding payment authorization request message is flagged, perform said operation of adding the indicator within the first data element of the clearing transaction message.

19. The system in accordance with claim 18,
said operation of receiving the clearing transaction message comprising receiving a clearing batch file containing a plurality of clearing transaction messages.

20. The system in accordance with claim 10,
said transaction comprising a single-message transaction, wherein the payment authorization request message includes the clearing transaction message.
